(19) United States
(12) Patent Application Publication
(10) Pub. No.: US 2026/0315942 A1
(43) Pub. Date: Oct. 15, 2026

(54) TRAVELING TOY

(71) Applicant: EPOCH COMPANY, LTD., Tokyo (JP)

(72) Inventor: Kei KAMIYAMA, Tokyo (JP)

(73) Assignee: EPOCH COMPANY, LTD., Tokyo (JP)

(21) Appl. No.: 19/644,976

(22) Filed: Apr. 10, 2026

(30) Foreign Application Priority Data
Apr. 14, 2025 (JP) 2025-066239

(51) Int. Cl. A63H 17/26

(52) U.S. Cl. CPC A63H 17/26

(57) ABSTRACT

A traveling toy includes a main body member including a seat portion, a movable member connected to the main body member, and an additional seat member supported by the movable member. In a case where the movable member is located in a first position, an additional region in which the additional seat member is disposed is not formed. In a case where the movable member is located in a second position, the additional region is formed. In a state in which the movable member is located in the second position and the additional seat member is disposed in the additional region, the additional seat member is supported by the movable member.

### CROSS-REFERENCE TO RELATED APPLICATIONS

This application is based on and claims priority under 35 USC 119 from Japanese Patent Application No. 2025-066239 filed on Apr. 14, 2025, the contents of which are incorporated herein by reference.

### TECHNICAL FIELD

The present disclosure relates to a traveling toy.

### BACKGROUND ART

Patent Literature 1 discloses a traveling toy simulating an open car.

### CITATION LIST

### PATENT LITERATURE

PATENT LITERATURE 1: JP2025-023382A

### SUMMARY OF INVENTION

In the traveling toy according to Patent Literature 1, a doll can be placed on a seat in a vehicle interior member. However, in the traveling toy according to Patent Literature 1, the maximum number of dolls that can be placed in the traveling toy is predetermined and cannot be changed. Therefore, in order to increase the maximum number of dolls that can be placed in the traveling toy, for example, it is necessary to increase the number of seats or to widen the seats, and thus the traveling toy becomes large in size.

An object of the present disclosure is to provide a traveling toy capable of changing the maximum number of dolls that can be placed in the traveling toy while restraining an increase in size of the traveling toy.

A traveling toy according to the present disclosure includes a main body member including a seat portion on which a first doll is placed; a movable member connected to the main body member and movable to change a position with respect to the main body member; and an additional seat member supported by the movable member and on which a second doll is placed. In a case where the movable member is located in a first position, an additional region in which the additional seat member is disposed is not formed. In a case where the movable member is located in a second position, the additional region is formed. In a state in which the movable member is located in the second position and the additional seat member is disposed in the additional region, the additional seat member is supported by the movable member.

According to the above configuration, it is possible to provide a traveling toy capable of changing the maximum number of dolls that can be placed in the traveling toy while restraining an increase in size of the traveling toy.

### BRIEF DESCRIPTION OF DRAWINGS

FIG. 1 is a perspective front view of a traveling toy according to an embodiment (hereinafter, also referred to as the present embodiment) of the present disclosure;

FIG. 2 is a perspective rear view of the traveling toy according to the present embodiment;

FIG. 3 is a perspective front view of the traveling toy in a state in which a movable member and additional seat members are removed;

FIG. 4 is a plan view of the traveling toy when the movable member is located in a second position;

FIG. 5 is a perspective front view of the movable member according to the present embodiment;

FIG. 6 is a plan view of the traveling toy when the movable member is located in a first position; and

FIG. 7 is a diagram illustrating a rear portion of the traveling toy.

### DESCRIPTION OF EMBODIMENTS

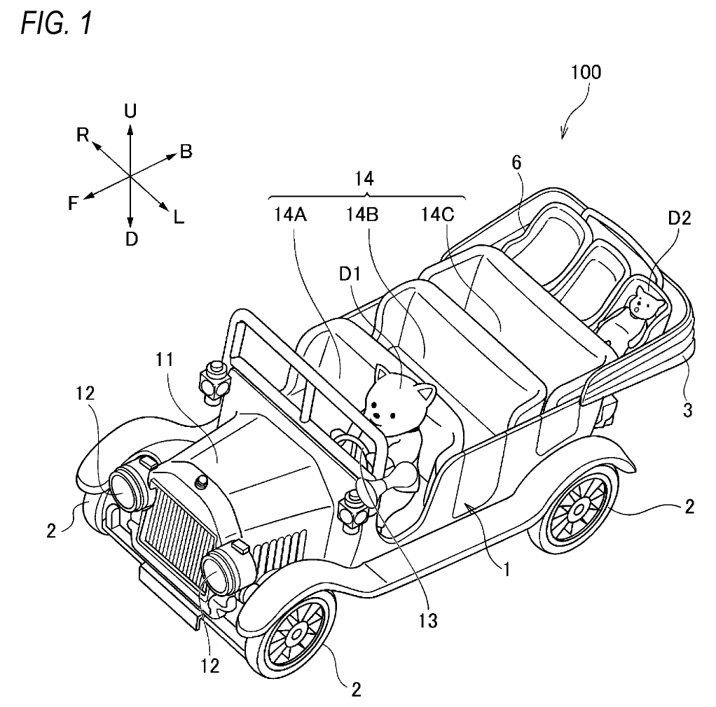

Hereinafter, a traveling toy 100 according to an embodiment of the present disclosure will be described in detail with reference to the drawings. In the description of the present embodiment, for convenience of description, a "left-right direction", an "up-down direction", and a "front-rear direction" may be appropriately referred to. These directions are relative directions set for the traveling toy 100 shown in FIG. 1. In the present embodiment, a traveling direction of the traveling toy 100 refers to the forward direction. Here, the "left-right direction" is a direction including "leftward" and "rightward". The "up-down direction" includes "upward" and "downward". The "front-rear direction" includes "forward" and "rearward". In the drawings, a reference sign U indicates upward. A reference sign D indicates downward. A reference sign L indicates leftward. A reference sign R indicates rightward. A reference sign F indicates forward. A reference sign B indicates rearward.

### Overall Configuration

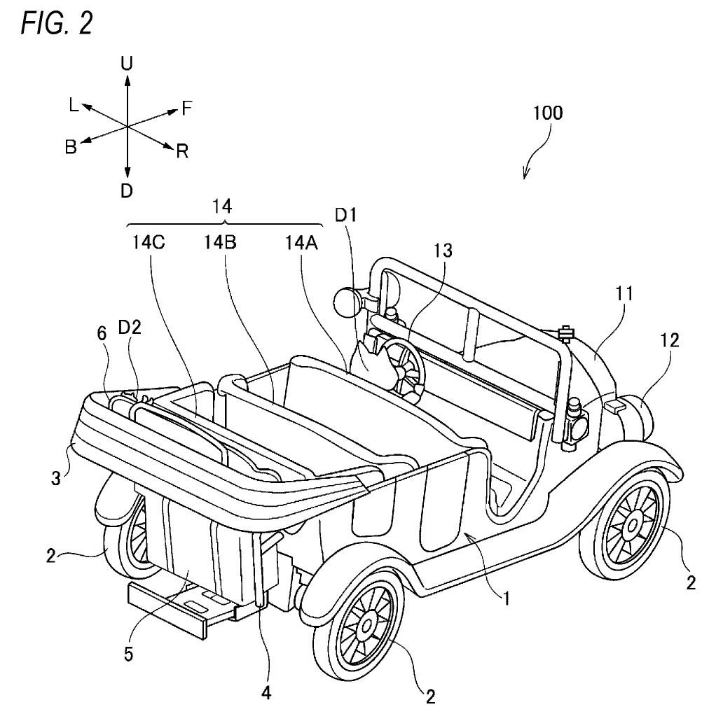

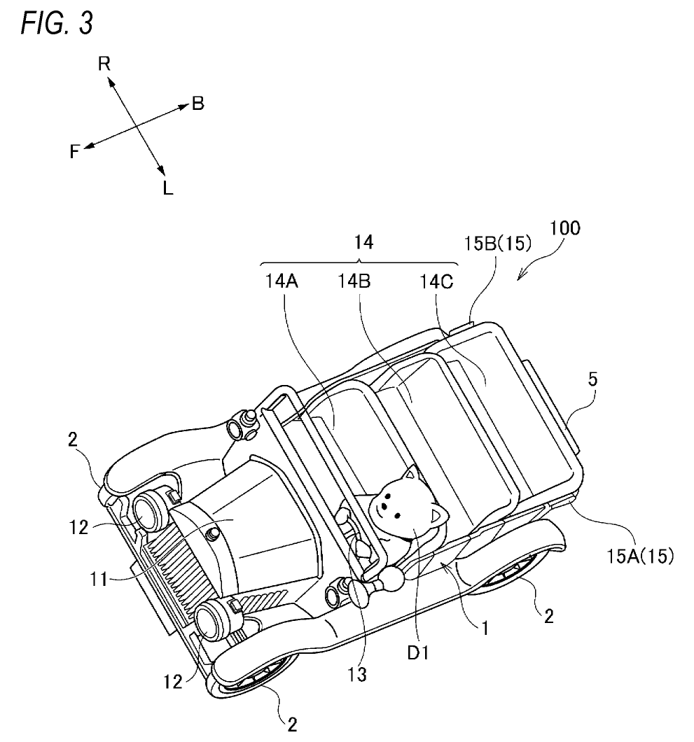

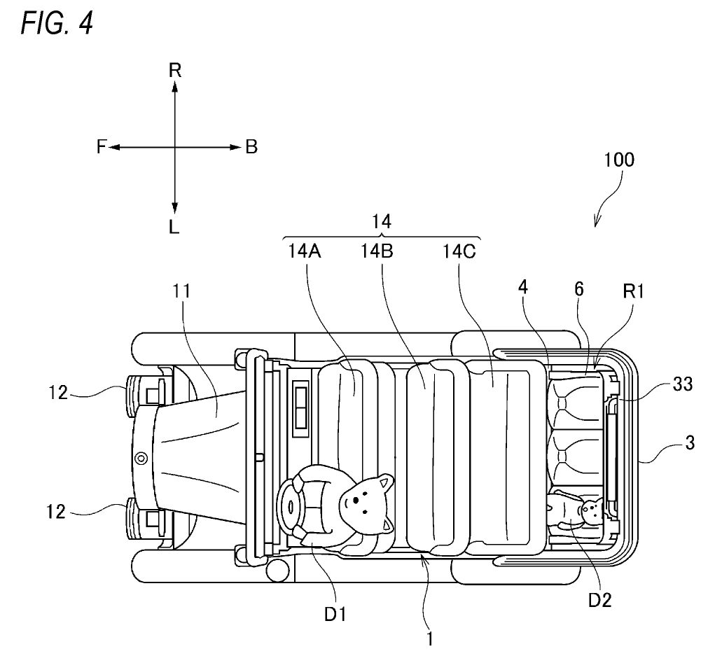

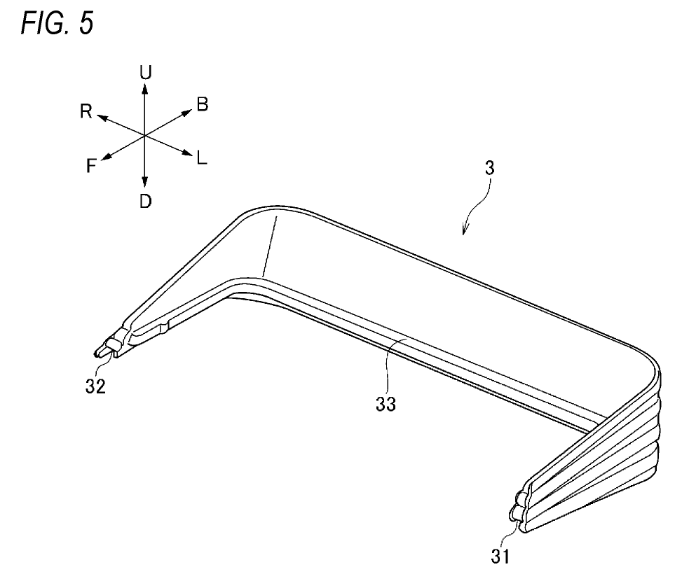

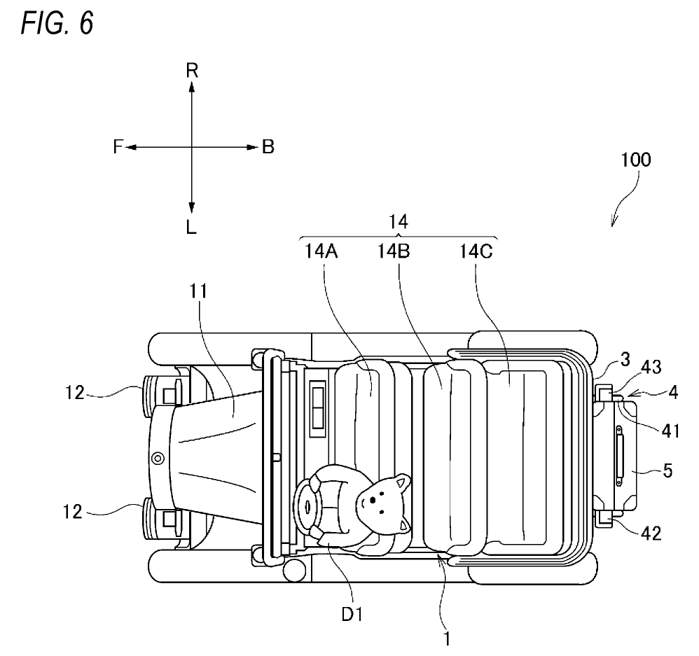

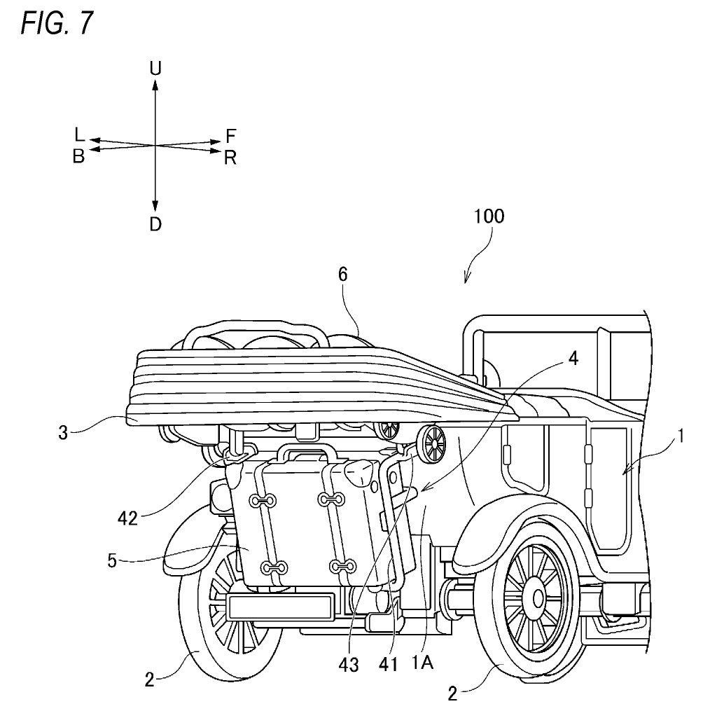

First, the overall configuration of the traveling toy 100 will be described with reference to FIGS. 1-7. FIG. 1 is a perspective front view of the traveling toy 100 according to the present embodiment. FIG. 2 is a perspective rear view of the traveling toy 100 according to the present embodiment. FIG. 3 is a perspective front view of the traveling toy 100 in a state in which a movable member 3 and additional seat members 6 are removed. FIG. 4 is a plan view of the traveling toy 100 when the movable member 3 is located in a second position. FIG. 5 is a perspective front view of the movable member 3 according to the present embodiment. FIG. 6 is a plan view of the traveling toy 100 when the movable member 3 is located in a first position. FIG. 7 is a diagram illustrating a rear portion of the traveling toy 100. As shown in FIGS. 1 and 2, the traveling toy 100 includes a main body member 1, four wheel members 2, the movable member 3, a support portion 4, a bag toy 5, and the additional seat members 6.

As shown in FIGS. 1-3, the main body member 1 includes a front portion 11, two light portions 12, a handle portion 13, a seat portion 14, and a rail portion 15. The front portion 11 is provided on the front side of the main body member 1. The light portion 12 simulates a vehicle headlamp. The light portions 12 are provided on a right side portion 11R and a left side portion 11L of the front portion 11, respectively. The handle portion 13 has a substantially circular shape. The handle portion 13 is located between the front portion 11 and the seat portion 14.

The seat portion 14 is located behind the handle portion 13. The seat portion 14 includes a first seat portion 14A, a second seat portion 14B, and a third seat portion 14C. The first seat portion 14A is provided substantially at the center of the main body member 1. The second seat portion 14B is provided behind the first seat portion 14A. The third seat portion 14C is provided behind the second seat portion 14B. For example, one or more dolls can be placed on the first seat portion 14A, the second seat portion 14B, and the third seat portion 14C. In the states shown in FIGS. 1-4 and 6, a first doll D1 is placed on the first seat portion 14A.

As shown in FIG. 3, the rail portion 15 includes a first rail portion 15A and a second rail portion 15B. The first rail portion 15A is provided in a left side surface portion of a rear portion of the main body member 1 so as to extend in a longitudinal direction of the main body member 1. The second rail portion 15B is provided in a right side surface portion of the rear portion of the main body member 1 so as to extend in the longitudinal direction of the main body member 1. The first rail portion 15A and the second rail portion 15B are substantially rectangular parallelepiped members with rounded corners. The first rail portion 15A and the second rail portion 15B are configured to allow the movable member 3 to slide thereon.

As shown in FIGS. 1 and 2, the wheel member 2 is a disk-shaped member. The wheel members 2 are rotatably connected to left and right ends of the front portion 11 and the rear portion of the main body member 1, respectively. The traveling toy 100 is movable in a predetermined direction (in the present embodiment, the front-rear direction in FIG. 1) by rotation of the wheel members 2. In the present embodiment, the forward direction is referred to as the traveling direction of the traveling toy 100.

As shown in FIG. 4, the movable member 3 has a shape simulating a hood and is formed in a substantially U shape in the top view. As shown in FIG. 5, the movable member 3 includes a first end portion 31 provided in a left front portion of the movable member 3, a second end portion 32 provided in a right front portion of the movable member 3, and a contact portion 33. As shown in FIGS. 1, 2, and 4, the movable member 3 is connected to the main body member 1 in a state of being detachable from the main body member 1. When the movable member 3 is connected to the main body member 1, the first end portion 31 slides on the first rail portion 15A (see FIG. 3) and the second end portion 32 slides on the second rail portion 15B (see FIG. 3), whereby the movable member 3 can slide on the rail portion 15 (see FIG. 3). More specifically, when the movable member 3 is connected to the main body member 1, the movable member 3 is movable in the forward direction (the traveling direction of the traveling toy 100) or the rearward direction (a direction opposite to the traveling direction of the traveling toy 100). Therefore, when the movable member 3 is connected to the main body member 1, the movable member 3 is movable to change a position thereof with respect to the main body member 1.

When the movable member 3 is in the state shown in FIG. 6, an additional region R1 (see FIG. 4) in which the additional seat members 6 can be disposed is not formed. In the present embodiment, the position of the movable member 3 in the state shown in FIG. 6 is referred to as the first position. On the other hand, when the movable member 3 is in the state shown in FIG. 4, the additional region R1 is formed behind the third seat portion 14C. In the present embodiment, the position of the movable member 3 in the state shown in FIG. 4 is referred to as the second position. That is, for example, when the movable member 3 is located in a front end portion of the rail portion 15, the additional region R1 is not formed, whereas when the movable member 3 is located in a rear end portion of the rail portion 15, the additional region R1 is formed behind the third seat portion 14C.

As shown in FIGS. 4 and 5, the contact portion 33 is provided in a rear portion of the movable member 3. The contact portion 33 is contactable with the additional seat members 6. When the movable member 3 is located in the second position, the additional region R1 is formed, and the additional seat members 6 are disposed in the additional region R1, the contact portion 33 comes into contact with the additional seat members 6 to support the additional seat members 6. That is, in the state shown in FIG. 4, the contact portion 33 supports the additional seat members 6 by coming into contact with the additional seat members 6. Accordingly, the movable member 3 can support the additional seat members 6. That is, the movable member 3 functions as a support member for the additional seat members 6.

As shown in FIG. 7, the support portion 4 is connected to a rear end portion 1A of the main body member 1. The support portion 4 includes an accommodation portion 41, a first placement portion 42, and a second placement portion 43. The accommodation portion 41 accommodates the bag toy 5. In the state shown in FIG. 7, the bag toy 5 is accommodated in the accommodation portion 41. The first placement portion 42 is provided at a left end portion of the support portion 4. The second placement portion 43 is provided at a right end portion of the support portion 4. In the state shown in FIG. 7, a part of bottom surfaces of the additional seat members 6 is placed on the first placement portion 42 and the second placement portion 43. That is, when the movable member 3 is located in the second position, the additional region R1 (see FIG. 4) is formed, and the additional seat members 6 are disposed in the additional region R1, the first placement portion 42 and the second placement portion 43 support the additional seat members 6. Accordingly, the support portion 4 can support the additional seat members 6.

As shown in FIG. 4, the additional seat members 6 can be disposed in the additional region R1. The additional seat members 6 are located behind the third seat portion 14C in a state of being disposed in the additional region R1. As shown in FIGS. 4 and 7, the additional seat members 6 are supported by the contact portion 33 of the movable member 3 and the first placement portion 42 and the second placement portion 43 of the support portion 4 in the state of being disposed in the additional region R1. For example, one or more dolls can be placed on the additional seat members 6. In the states shown in FIGS. 1-4, a second doll D2 is placed on the additional seat member 6.

### Method of Changing the Maximum Number of Dolls Placeable on Traveling Toy 100

Next, a method of changing the maximum number of dolls that are placeable on the traveling toy 100 will be described with reference to FIGS. 4 and 6. In the state shown in FIG. 6, since the movable member 3 is located in the front end portion of the rail portion 15 (that is, the movable member 3 is located in the first position), the additional region R1 (see FIG. 4) is not formed. Therefore, in the state shown in FIG. 6, the doll can be placed only on the seat portion 14 (the first seat portion 14A, the second seat portion 14B, and the third seat portion 14C).

On the other hand, in the state shown in FIG. 6, when a user of the traveling toy 100 slides the movable member 3 rearward on the rail portion 15, the state of the traveling toy 100 becomes the state shown in FIG. 4. In this way, when the movable member 3 is located in the rear end portion of the rail portion 15 (that is, when the movable member 3 is located in the second position), the additional region R1 is formed behind the third seat portion 14C. That is, when the user of the traveling toy 100 moves the movable member 3 on the rail portion 15 in the direction opposite to the traveling direction of the traveling toy 100 (that is, the rearward direction), the additional region R1 is formed behind the third seat portion 14C. Therefore, in the state shown in FIG. 4, the user of the traveling toy 100 can place the dolls not only on the seat portion 14 but also on the additional seat member 6 by disposing the additional seat members 6 in the additional region R1. That is, the user of the traveling toy 100 can place the first doll D1 on the seat portion 14 and place the second doll D2 on the additional seat member 6 by disposing the additional seat members 6 in the additional region R1. Therefore, the maximum number of dolls that can be placed in the traveling toy 100 in the state shown in FIG. 4 is larger than the maximum number of dolls that can be placed in the traveling toy 100 in the state shown in FIG. 6. In this way, the user can change the maximum number of dolls that can be placed in the traveling toy 100 (in the example described here, the maximum number of dolls that can be placed in the traveling toy 100 can be increased).

As described above, according to the traveling toy 100 of the present embodiment, when the user of the traveling toy 100 moves the movable member 3 from the first position to the second position, the additional region R1 is formed. Then, the user can dispose the additional seat members 6 in the additional region R1. In the state in which the additional seat members 6 are disposed in the additional region R1, the additional seat members 6 are supported by the movable member 3. Therefore, the user can place not only the first doll D1 but also the second doll D2 in the traveling toy 100 by disposing the additional seat members 6 in the additional region R1 formed by moving the movable member 3 from the first position to the second position. As described above, according to the traveling toy 100, it is possible to change the maximum number of dolls that can be disposed in the traveling toy 100 while restraining an increase in size of the traveling toy 100.

According to the traveling toy 100 of the present embodiment, the user can move the movable member 3 from the first position to the second position by only sliding the movable member 3 on the rail portion 15. When the movable member 3 moves from the first position to the second position, the additional region R1 in which the additional seat members 6 can be disposed is formed. As described above, according to the traveling toy 100, the user can change the maximum number of dolls that can be disposed in the traveling toy 100 with a simple operation.

Further, according to the traveling toy 100 of the present embodiment, by using the movable member 3 having the shape simulating a hood as the support member of the additional seat members 6, it is possible to easily support the additional seat members 6 without impairing the design.

According to the traveling toy 100 of the present embodiment, in the state in which the movable member 3 is located in the second position, the additional seat members 6 are supported by the movable member 3 through contact with the contact portion 33 of the movable member 3. Therefore, according to the traveling toy 100, the additional seat members 6 can be supported with a relatively simple configuration.

Further, according to the traveling toy 100 of the present embodiment, in the state in which the movable member 3 is located in the second position, the additional seat members 6 are supported by the support portion 4 by coming into contact with the support portion 4. Therefore, according to the traveling toy 100, the additional seat members 6 can be supported with a relatively simple configuration.

Further, according to the traveling toy 100 of the present embodiment, the user can form the additional region R1 in which the additional seat members 6 can be disposed by only moving the movable member 3 in the direction (the rearward direction) opposite to the traveling direction (the forward direction) of the traveling toy 100. When the user wants to form the additional region R1, the user moves the movable member 3 in the rearward direction, so that it is also possible to prevent the design of the traveling toy 100 from being impaired. As described above, according to the traveling toy 100, it is possible to easily change the maximum number of dolls that can be disposed in the traveling toy 100, and it is also possible to restrain a decrease in the design of the traveling toy 100.

According to the embodiment of the present disclosure described above, it is possible to provide a traveling toy according to the following aspects.

A traveling toy according to a first aspect includes: a main body member including a seat portion on which a first doll is allowed to be placed; a movable member connected to the main body member and being capable of moving to change a position with respect to the main body member; and an additional seat member being capable of being supported by the movable member and on which a second doll is placed, in which no additional region in which the additional seat member is disposed is formed when the movable member is located in a first position, and the additional region is formed when the movable member is located in a second position, and the additional seat member is supported by the movable member in a state in which the movable member is located in the second position and the additional seat member is disposed in the additional region.

With such a configuration, the additional region is formed by moving the movable member, which is capable of moving to change the position with respect to the main body member, from the first position to the second position. Further, the additional seat member can be disposed in the additional region, and the additional seat member is supported by the movable member in the state of being disposed in the additional region. Therefore, the user can place not only the first doll but also the second doll on the traveling toy by disposing the additional seat member in the additional region formed by moving the movable member from the first position to the second position. As described above, according to the traveling toy having the above configuration, it is possible to change the maximum number of dolls that can be disposed in the traveling toy while restraining an increase in size of the traveling toy.

In the traveling toy according to a second aspect, the main body member includes a rail portion on which the movable member is slidable, the rail portion is provided on the main body member to extend in a longitudinal direction of the main body member, and the movable member moves from the first position to the second position by sliding on the rail portion.

With such a configuration, the user can move the movable member from the first position to the second position by only sliding the movable member on the rail portion. As described above, according to the traveling toy having the above configuration, the user can change the maximum number of dolls that can be disposed in the traveling toy with a simple operation.

In the traveling toy according to a third aspect, the rail portion includes a first rail portion and a second rail portion respectively provided on both side surfaces of the main body member, the movable member has a shape simulating a hood and is formed in a substantially U shape in a top view, and a first end portion of the movable member slides on the first rail portion, and a second end portion of the movable member slides on the second rail portion.

With such a configuration, by using the movable member having the shape simulating a hood as the support member of the additional seat member, it is possible to easily support the additional seat member without impairing the design.

In the traveling toy according to a fourth aspect, the movable member includes a contact portion capable of coming into contact with the additional seat member, and in a state in which the movable member is located in the second position, the additional seat member is supported by the movable member by coming into contact with the contact portion. In the state in which the movable member is located in the second position, the additional seat member is supported by the movable member by coming into contact with the contact portion of the movable member. As described above, according to the traveling toy having the above configuration, the additional seat member can be supported with a relatively simple configuration.

With such a configuration, in the state in which the movable member is located in the second position, the additional seat member is supported by the movable member by coming into contact with the contact portion of the movable member. As described above, according to the traveling toy having the above configuration, the additional seat member can be supported with a relatively simple configuration.

The traveling toy according to a fifth aspect further includes a support portion connected to the main body member, in which the support portion is capable of coming into contact with the additional seat member, and in a state in which the movable member is located in the second position, the additional seat member is supported by the support portion by coming into contact with the support portion.

With such a configuration, in the state in which the movable member is located in the second position, the additional seat member is supported by the support portion by coming into contact with the support portion connected to the main body member. As described above, according to the traveling toy having the above configuration, the additional seat member can be supported with a relatively simple configuration.

The traveling toy according to a sixth aspect further includes a wheel member connected to the main body member, in which the traveling toy is movable in a predetermined direction by rotation of the wheel member, and the movable member moves from the first position to the second position by moving in a direction opposite to a traveling direction of the traveling toy.

With such a configuration, the user can form the additional region in which the additional seat member can be disposed by only moving the movable member in the direction opposite to the traveling direction of the traveling toy. Further, when the user wants to form the additional region, the user moves the movable member in the direction opposite to the traveling direction of the traveling toy, so that it is also possible to prevent the design of the traveling toy from being impaired. As described above, according to the traveling toy having the above configuration, it is possible to easily change the maximum number of dolls that can be disposed in the traveling toy, and it is also possible to restrain a decrease in the design of the traveling toy.

The above embodiment is intended to facilitate the understanding of the present disclosure, and does not limit the present disclosure. The present disclosure can be changed or improved without departing from the gist thereof.

In the present embodiment, the traveling toy 100 includes the main body member 1, the wheel members 2, the movable member 3, the support portion 4, the bag toy 5, and the additional seat members 6, but the traveling toy 100 may not include, for example, the support portion 4 and the bag toy 5.

In the present embodiment, the main body member 1 includes the front portion 11, the light portions 12, the handle portion 13, the seat portion 14, and the rail portion 15, but the main body member 1 may not include, for example, the front portion 11, the light portions 12, the handle portion 13, and the rail portion 15. In this case, the main body member 1 includes, for example, a plurality of attachment portions for detachably attaching the movable member 3 to the main body member 1 instead of the rail portion 15, and the user changes the position of the movable member 3 by attaching the movable member 3 to one attachment portion selected from the plurality of attachment portions. That is, in this case, the user changes the position of the movable member 3 from the first position to the second position by removing the movable member 3 attached to the attachment portion for setting the position of the movable member 3 to the first position and then attaching the movable member 3 to the attachment portion for setting the position of the movable member 3 to the second position. Accordingly, the method of moving the movable member 3 from the first position to the second position is not limited to the sliding.

In the present embodiment, the seat portion 14 includes three seat portions (the first seat portion 14A, the second seat portion 14B, and the third seat portion 14C), but the seat portion 14 may include one seat portion, two seat portions, or four or more seat portions.

In the present embodiment, the bag toy 5 may be detachable in the state in which the additional seat members 6 are disposed in the additional region R1. In this case, the user can take out the bag toy 5 accommodated in the accommodation portion 41 from the accommodation portion 41 in the state in which the additional seat members 6 are disposed in the additional region R1.

In the present embodiment, the rail portion 15 includes the first rail portion 15A and the second rail portion 15B, but the rail portion 15 may include only one of the first rail portion 15A and the second rail portion 15B, for example. Further, the rail portion 15 may include, for example, the first rail portion 15A, the second rail portion 15B, and another rail portion different from the first rail portion 15A and the second rail portion 15B.

In the present embodiment, the movable member 3 has the shape simulating a hood and is formed in the substantially U shape in the top view, but the movable member 3 may have another shape.

In the present embodiment, the movable member 3 moves in the direction (the rearward direction) opposite to the traveling direction (the forward direction) of the traveling toy 100, but the moving direction of the movable member 3 is not limited to this direction (the front-rear direction).

What is claimed is:

1. A traveling toy comprising:
a main body member including a seat portion on which a first doll is placed;
a movable member connected to the main body member and moved to change a position with respect to the main body member; and
an additional seat member supported by the movable member and on which a second doll is placed, wherein
in a case where the movable member is located in a first position, an additional region in which the additional seat member is disposed is not formed,
in a case where the movable member is located in a second position, the additional region is formed, and
in a state in which the movable member is located in the second position and the additional seat member is disposed in the additional region, the additional seat member is supported by the movable member.

2. The traveling toy according to claim 1, wherein
the main body member includes a rail portion on which the movable member is slidable,
the rail portion is provided on the main body member to extend in a longitudinal direction of the main body member, and
the movable member moves from the first position to the second position by sliding on the rail portion.

3. The traveling toy according to claim 2, wherein
the rail portion includes a first rail portion and a second rail portion respectively provided on both side surfaces of the main body member,
the movable member has a shape simulating a hood and is formed in a U-shape in a top view, and
a first end portion of the movable member slides on the first rail portion, and a second end portion of the movable member slides on the second rail portion.

4. The traveling toy according to claim 1, wherein
the movable member includes a contact portion contactable with the additional seat member, and
in a state in which the movable member is located in the second position, the additional seat member is supported by the movable member through contact with the contact portion.

5. The traveling toy according to claim 1, further comprising:
a support portion connected to the main body member, wherein
the support portion is contactable with the additional seat member, and
in a state in which the movable member is located in the second position, the additional seat member is supported by the support portion through contact with the support portion.

6. The traveling toy according to claim 1, further comprising:
a wheel member connected to the main body member, wherein
the traveling toy is movable in a predetermined direction by rotation of the wheel member, and
the movable member moves from the first position to the second position by moving in a direction opposite to a traveling direction of the traveling toy.
